(19) United States
(12) Patent Application Publication
(10) Pub. No.: US 2024/0291370 A1
(43) Pub. Date: Aug. 29, 2024

(54) SUPERCONDUCTING MOTOR COMPRISING A COOLING SYSTEM

(71) Applicant: Airbus SAS, BLAGNAC (FR)

(72) Inventors: Alexandre COLLE, BLAGNAC (FR); Reda ABDOUH, BLAGNAC (FR)

(21) Appl. No.: 18/585,341

(22) Filed: Feb. 23, 2024

(30) Foreign Application Priority Data
Feb. 27, 2023 (FR) 2301800

(51) Int. Cl. H02K 55/02; H02K 1/20; H02K 1/278

(52) U.S. Cl. CPC H02K 55/02; H02K 1/20; H02K 1/278

(57) ABSTRACT

A superconducting motor comprising a rotor with permanent magnets that is rotatable about a longitudinal axis, a stator outside the rotor and comprising a non-magnetic support cylinder and a ferromagnetic magnetic cylinder, wherein the support cylinder is passed through by several orifices, wherein, for each orifice, the magnetic cylinder has a cutout facing the orifice, for each pair of orifices, a coil that is made up of a superconducting material and that is wound by being accommodated in the orifices of the pair, and, for each cutout, a cooling system arranged in the cutout for cooling that portion of the coil which is accommodated in the orifice corresponding to the cutout.

### CROSS-REFERENCES TO RELATED APPLICATIONS

This application claims the benefit of French Patent Application Number 2301800 filed on Feb. 27, 2023, the entire disclosure of which is incorporated herein by way of reference.

### FIELD OF THE INVENTION

The present invention relates to the general field of superconducting motors and more particularly to superconducting motors comprising a cooling system.

### BACKGROUND OF THE INVENTION

FIG. 3 shows a superconducting motor 300 of the prior art in which the superconducting motor 300 is viewed in section through a plane perpendicular to the longitudinal axis X of said superconducting motor 300.

The superconducting motor 300 comprises a rotor 302 which has a rotor core 304 made of a ferromagnetic material such as the collection of iron alloys used for electric machines. The rotor core 304 is cylindrical and coaxial with the longitudinal axis X and it has a central bore 306 in which a motor shaft 308 of said superconducting motor 300 is rigidly fitted and fastened. The motor shaft 308 is coaxial with the longitudinal axis X.

The rotor 302 also comprises permanent magnets 310 that are fastened to the rotor core 304 over the periphery of the latter. There are several permanent magnets 310 (in this case six) distributed angularly and regularly around the rotor core 304 and spaced apart from one another. Conventionally, the permanent magnets 310 are magnetized radially with respect to the longitudinal axis X in alternating fashion from one magnet to the next.

The superconducting motor 300 comprises a stator 312 disposed outside the rotor 302 and comprises a stator core 314 made of a ferromagnetic material such as the collection of iron alloys used for electric machines. The stator core 314 has a cylindrical overall shape that is coaxial with the longitudinal axis X.

On its cylindrical face oriented towards the rotor 302, the stator core 314 has slots 316 which in this case open out towards the rotor 302. There are several slots 316 (in this case sixteen) distributed angularly and regularly around the rotor core 302. The slots 316 are arranged in pairs and the two slots 316 of the pair are separated by a tooth 318 formed in one piece and materially integrally with the stator core 314.

For each pair of slots 316, the stator 312 comprises a coil 320 which is wound around the tooth 318. Each coil 320 is made up of a superconducting material.

The rotor 302 and the stator 312 are conventionally accommodated in a motor housing 322 which is cylindrical and closed at its two ends by flanks, of which at least one is pierced by a central orifice allowing the passage of the motor shaft 308. The stator 312 is fixedly mounted inside the motor housing 322, whereas the rotor 302 and the motor shaft 308 are mounted so as to be able to rotate freely inside the motor housing 322.

In operation, each coil 320 is electrically powered to generate a magnetic field which interacts with the permanent magnets 310 so as to drive them in rotation with the rotor 302 and the motor shaft 308.

The superconducting motor 300 comprises an inner cylinder 324 and an outer cylinder 326 which are coaxial with the longitudinal axis X.

The inner cylinder 324 is disposed between the rotor 302 and the stator 312, and the outer cylinder 326 is disposed around the stator 312 and inside the motor housing 322.

The inner cylinder 324 and the outer cylinder 326 extend between the two flanks to which they are hermetically fastened so as to delimit, between them and the two flanks, a chamber 328 in which the stator 312 is accommodated and which can be evacuated.

In the context of a superconducting motor 300, the coils 320 must be cooled in order to improve their performance. To this end, for each slot 316, tubes 330 are disposed in the bottom of the slot 316 between the coil 320 accommodated in the slot 316 and the stator core 314. These tubes 330 are fluidically connected to a source of a refrigerant fluid. The refrigerant fluid is then injected into the tubes 330 to cool the coils 320.

The magnetic field created by the permanent magnets 310 is deflected by the rotor core 304 and the induced magnetic field created by the coils 320 is intensified on the superconductors by the presence of the slots 316, thus inducing a degradation in the operation of the coils 320, and it is desirable to find an arrangement which improves the performance of the superconducting motor.

### SUMMARY OF THE INVENTION

An object of the present invention is to propose a superconducting motor comprising:
a rotor, with a rotor core, that bears permanent magnets and is rotatable about a longitudinal axis,
a stator disposed outside the rotor and comprising a support cylinder and a magnetic cylinder, wherein the support cylinder is fitted and fastened in the magnetic cylinder, wherein the magnetic cylinder is made of a ferromagnetic material, wherein the support cylinder is made of a non-magnetic and electrically insulating material, wherein the support cylinder is passed through by several orifices that are angularly and regularly distributed around the rotor, wherein, for each orifice, the magnetic cylinder has a deep cutout inside the magnetic cylinder and facing said orifice,
for each pair of orifices, a coil that is made up of a superconducting material and that is wound by being accommodated in the orifices of the pair, and
for each cutout, a cooling system arranged in said cutout and intended to cool that portion of the coil which is accommodated in the orifice corresponding to the cutout.

With such an arrangement, the performance of the motor is improved.

Advantageously, each orifice opens at the outer surface of the support cylinder.

Advantageously, each coil is made up of a strip of a superconducting material that is wound on itself about an overall radial winding axis with respect to the longitudinal axis.

Advantageously, each cooling system is made up of a plurality of tubes disposed in the corresponding cutout, the tubes extend over the length of the magnetic cylinder and are intended to be fluidically connected to a source of a refrigerant fluid. Advantageously, the tubes are made of metal.

### BRIEF DESCRIPTION OF THE DRAWINGS

The features of the invention mentioned above, along with others, will become more clearly apparent upon reading the following description of one exemplary embodiment, said description being given with reference to the appended drawings, in which:

FIG. 1 is a view in section of a superconducting motor according to the invention,

FIG. 2 is an enlarged view of detail II in FIG. 1, and

FIG. 3 is a view in section of a superconducting motor of the prior art.

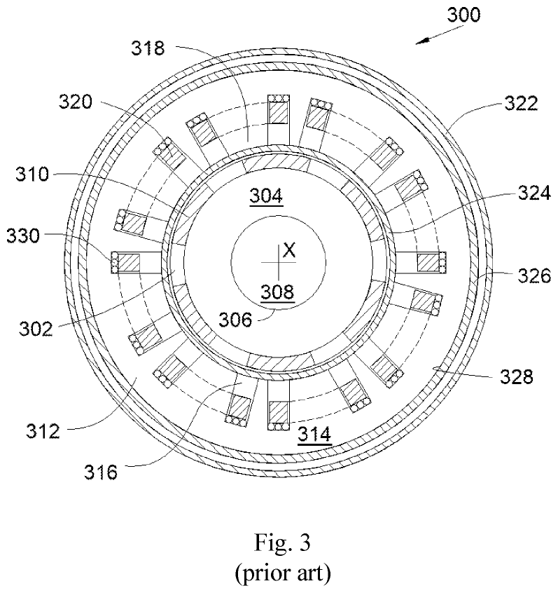

### DETAILED DESCRIPTION OF THE PREFERRED EMBODIMENTS

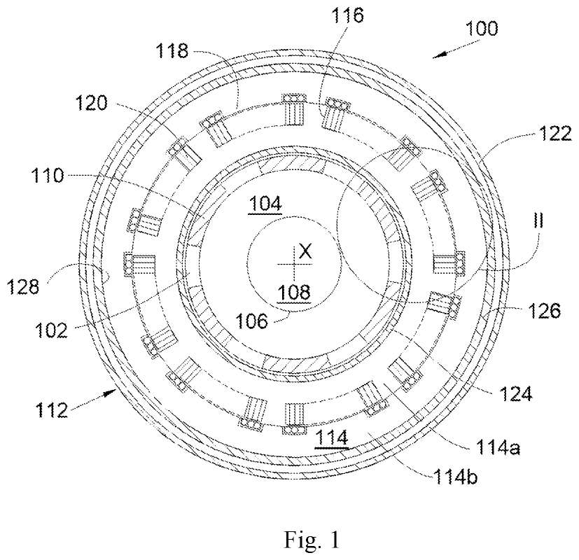

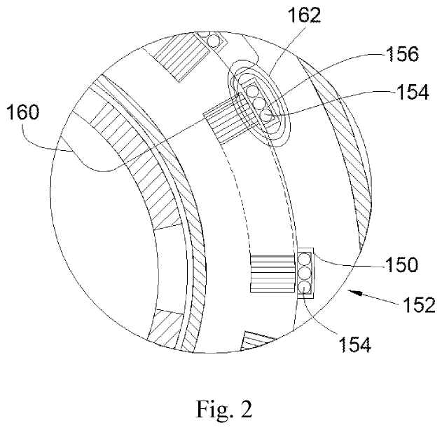

FIG. 1 shows a superconducting motor 100 according to the invention in section through a plane perpendicular to the longitudinal axis X of the superconducting motor 100, and FIG. 2 shows an enlarged view of detail II. The superconducting motor 100 has the same structure overall as the superconducting motor 300 of the prior art.

The superconducting motor 100 comprises a rotor 102 which is rotatable about the longitudinal axis X and which has a rotor core 104 made of a ferromagnetic material such as the collection of iron alloys used for electric machines. The rotor core 104 is cylindrical and coaxial with the longitudinal axis X and it has a central bore 106 in which a motor shaft 108 of said superconducting motor 100 is rigidly fitted and fastened. The motor shaft 108 is coaxial with the longitudinal axis X.

The rotor 102 also comprises permanent magnets 110 that are fastened to the rotor core 104 over the periphery of the latter. There are several permanent magnets 110 (in this case six) distributed angularly and regularly around the rotor core 104 and spaced apart from one another. Conventionally, the permanent magnets 110 are magnetized radially with respect to the longitudinal axis X in alternating north-south fashion from one magnet to the next.

The superconducting motor 100 comprises a stator 112 disposed outside the rotor 102 and comprising a stator core 114. The stator core 114 is made up of two concentric cylinders that are coaxial with the longitudinal axis X, namely a support cylinder 114a and a magnetic cylinder 114b, wherein the support cylinder 114a is fitted and fastened in the magnetic cylinder 114b.

The magnetic cylinder 114b is made of a ferromagnetic material such as steel.

The support cylinder 114a is made of a non-magnetic and electrically insulating material and serves as a support for the coils 120 as is explained below. According to a particular embodiment, the electrical conductivity of the support cylinder 114a is less than 1 S/m, and preferably less than 10¹ S/m. The support cylinder 114a is passed through by several orifices 116 (in this case sixteen) distributed angularly and regularly around the rotor 102, and they are even in number.

For each pair of orifices 116, the superconducting motor 100 comprises a coil 120 which is wound by being accommodated in the orifices 116 of the pair. Each coil 120 is made up of a superconducting material and is preferably made up of a strip of a superconducting material that is wound on itself about an overall radial winding axis with respect to the longitudinal axis X. The hatchings shown in the sections of the coils 120 show the layers of the strip.

In the embodiment of the invention presented here, the rotor 102 and the stator 112 are accommodated in a motor housing 122 which is cylindrical and closed at its two ends by flanks, of which at least one is pierced by a central orifice allowing the passage of the motor shaft 108. The stator 112 is fixedly mounted inside the motor housing 122, whereas the rotor 102 and the motor shaft 108 are mounted so as to be able to rotate freely inside the motor housing 122.

In operation, each coil 120 is electrically powered by an alternating current to generate a magnetic field which interacts with the permanent magnets 110 so as to drive them in rotation with the rotor 102 and the motor shaft 108.

As for the superconducting motor 300 of the prior art, the superconducting motor 100, in the embodiment of the invention presented here, comprises an inner cylinder 124 and an outer cylinder 126 which are coaxial with the longitudinal axis X.

The inner cylinder 124 is disposed between the rotor 102 and the stator 112, that is to say in this case the support cylinder 114a, and the outer cylinder 126 is disposed around the stator 112, that is to say in this case the magnetic cylinder 114b, and inside the motor housing 122.

The inner cylinder 124 and the outer cylinder 126 extend between the two flanks to which they are hermetically fastened so as to delimit, between them (the two inner 124 and outer 126 cylinders) and the two flanks, a chamber 128 in which the stator 112 is accommodated and which can be evacuated.

The orifices 116 are in the vicinity of the outer periphery of the support cylinder 114a, and as shown in FIGS. 1 and 2, each orifice 116 opens at the outer surface of the support cylinder 114a, i.e. opposite the magnetic cylinder 114b. Thus each coil 120 is disposed in the vicinity of the magnetic cylinder 114b, that is to say over the outer periphery of the support cylinder 114a. For each orifice 116, the magnetic cylinder 114b has a deep cutout 150 inside the magnetic cylinder 114b. Each cutout 150 extends angularly about the longitudinal axis X generally over the same angular extent as the orifice 116. The cutout 150 faces the corresponding orifice 116. Between two successive cutouts 150, the magnetic cylinder 114b has a tooth 118 which remains at a distance from the coil 120. Each coil 120 remains in the volume delimited by the support cylinder 114a, and the teeth 118 remain beyond the support cylinder 114a and the coils 120.

Each cutout 150 extends over the length of the magnetic cylinder 114b parallel to the longitudinal axis X.

Arranged in each cutout 150 is a cooling system 152 intended to cool that portion of the coil 120 which is accommodated in the orifice 116 corresponding to the cutout 150. Thus, the cooling system 152 is disposed outside the coils 120 with respect to the longitudinal axis X and interferes little with the magnetic field of the permanent magnets 110, resulting in better performance of the superconducting motor 100. Each cooling system 152 is thus surrounded on three sides by the magnetic cylinder 114b.

The magnetic field created by the permanent magnets 110 is not deflected by the support cylinder 114a. In the case of coils 120 made up of a winding of a strip as explained above, the field lines 160 of the magnetic field created by the permanent magnets 110 are then generally parallel to the bands of the strip, thus limiting performance losses. Furthermore, the magnetic field created by the permanent magnets 110 is deflected around the cooling system 152 due to the presence of the magnetic cylinder 114b which is around said cooling system 152. The influence of the magnetic cylinder 114b on the induced magnetic field (162) created by the coils 120 remains low.

All these elements make it possible to provide better performance.

Each cooling system 152 is made up of a plurality of tubes 154 which are disposed in the corresponding cutout 150, that is to say outside of the support cylinder 114a and the magnetic cylinder 114b, and the tubes 154 extend over the length of the magnetic cylinder 114b. These tubes 154 are fluidically connected to a source of a refrigerant fluid and the refrigerant fluid is then injected into the tubes 154 to cool the coils 120 facing said tubes 154.

The tubes 154 are made of a material having a good thermal conductivity, for example metal such as copper alloy, to reduce the thermal gradient between the refrigerant fluid and the coils 120.

According to a particular embodiment, the tubes 154 have a good thermal conductivity of greater than 10 W/m·K and a good electrical conductivity of greater than 10⁶ S/m.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A superconducting motor comprising:
a rotor, with a rotor core, bearing a plurality of permanent magnets and rotatable about a longitudinal axis,
a stator disposed outside the rotor and comprising a support cylinder and a magnetic cylinder, wherein the support cylinder is fitted and fastened in the magnetic cylinder, wherein the magnetic cylinder is made of a ferromagnetic material, wherein the support cylinder is made of a non-magnetic and electrically insulating material, wherein the support cylinder is passed through by several orifices that are angularly and regularly distributed around the rotor in pairs, wherein, for each orifice, the magnetic cylinder has a cutout inside the magnetic cylinder and facing said orifice,
for each pair of orifices, a coil made of a superconducting material and that is wound by being accommodated in the orifices of the pair, and
for each cutout, a cooling system arranged in said cutout and intended to cool that portion of the coil which is accommodated in the orifice corresponding to the cutout.

2. The superconducting motor according to claim 1, wherein each orifice opens at an outer surface of the support cylinder.

3. The superconducting motor according to claim 1, wherein each coil is made up of a strip of a superconducting material that is wound about an overall radial winding axis with respect to the longitudinal axis.

4. The superconducting motor according to claim 1, wherein each cooling system is made up of a plurality of tubes disposed in the corresponding cutout, and
wherein the tubes extend over a length of the magnetic cylinder and are intended to be fluidically connected to a source of a refrigerant fluid.

5. The superconducting motor according to claim 4, wherein the tubes are made of metal.
